(19) United States
(12) Patent Application Publication
(10) Pub. No.: US 2012/0136738 A1
(43) Pub. Date: May 31, 2012

(54) ROYALTY CALCULATION ENGINE

(75) Inventors: Peter Meuer, Neckargenmuend (DE); Martina Fuchs, Dielheim (DE)

(73) Assignee: SAP AG, Waldorf (DE)

(21) Appl. No.: 12/955,664

(22) Filed: Nov. 29, 2010

(51) Int. Cl. G06Q 30/00

(52) U.S. Cl. 705/26.1

(57) ABSTRACT

A plurality of invoice records are identified relating to service-based software provided by an entity to at least one customer, the service-based software including at least one software component licensed from a vendor for use by the entity. An agreement object is identified associated with a license agreement between the entity and the vendor and associated with the software component, the license agreement including a plurality of license terms. The agreement object is associated with a calculation scheme based at least in part on the license terms, the calculation scheme including a set of calculation step objects from a plurality of reusable calculation step objects. At least one software royalty value is calculated for the license agreement, the calculation of the software royalty value based at least in part on the calculation scheme and invoice data, in the invoice records, corresponding to at least the software component.

### TECHNICAL FIELD

This present disclosure relates to royalty calculations, and more particularly generating royalty calculations using reusable calculation step objects.

### BACKGROUND

Modern software providers include large enterprise software service providers that provide multiple software tools, applications, and services to customers. Given the varying needs of customers and the finite resources of some software developers and providers, it is not uncommon for software providers to integrate software components from third-party entities into their own software products. In some instances, software components provided to a software provider from a third party can be licensed from the third party to the software provider for inclusion in software products sold or licensed by the software provider to its own customers. In some cases, software licenses include maintenance royalty provisions governing payment by the licensee to the licensor to compensate the licensor for work, maintenance, and service provided by the licensor in connection with the licensee's use of the licensed software.

In some instances, software components provided by a third party can be marketed under the same brand as the licensee's product, despite the licensee not being the sole developer of the product's underlying components. In other instances, the product or components, created by the third party and marketed by the software provider, can be referred to as “vendor-branded.” In some examples, royalties for the software components and maintenance associated with the software components can be affected by how the software product and underlying software components are branded. Indeed, a licensor of software components may provide multiple software components to a given licensee, particularly where the licensee/software provider markets many different software products and services. Moreover, software licenses governing the relationship between such vendor/licensors and software provider/licensees, and processing payment for such licenses can become quite complicated.

### SUMMARY

This disclosure provides various embodiments for managing and performing software royalty calculations using a royalty calculation engine. A plurality of invoice records can be identified in an enterprise resource system relating to service-based software provided by an entity to at least one customer of the entity, the service-based software including at least one first software component licensed from a first vendor for use by the entity. A first agreement object can be identified associated with a first license agreement between the entity and the first vendor and associated with the first software component, the first license agreement including a first plurality of license terms. The first agreement object can be associated with a first calculation scheme based at least in part on the first plurality of license terms, the first calculation scheme including a first set of calculation step objects from a plurality of reusable calculation step objects. At least one software royalty value can be calculated for the first license agreement, the calculation of the first software royalty value based at least in part on the first calculation scheme and first invoice data included in the plurality of invoice records, the first invoice data corresponding to at least the first software component. Additionally, in certain implementations, a first maintenance royalty value can also be calculated for the first license agreement over a particular period based at least in part on the first invoice data.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example system including a software royalty calculation engine.

FIG. 2 is a flowchart of an example technique for calculating a software royalty.

FIG. 3 is a schematic representation of one or more example agreement objects for use in a royalty calculation.

FIG. 4 is a flowchart of an example technique for generating a settlement run.

FIGS. 5A-5I are example screenshots of a user interface of a software royalty calculation engine.

FIG. 6 is a flowchart of an example technique for generating a calculation scheme.

Like reference symbols in the various drawings indicate like elements.

### DETAILED DESCRIPTION

This disclosure generally describes software, computer-implemented methods, and systems relating to a software royalty calculation engine adapted to generate a plurality of unique royalty calculation schemes using a set of reusable royalty calculation building blocks embodied, for example, in software objects. These royalty building blocks can be combined and re-combined to generate and modify calculation schemes that can be used by the royalty calculation engine to calculate software royalty payments due to third-party vendors who have provided software components included in software products sold by a particular entity. The royalty building blocks can allow for a multitude of calculation schemes to be built that are capable of calculating royalties for a wide array of software license agreements, terms, and vendors. Further, the royalty calculation engine can pull data from invoice and vendor records to identify sales or uses of software products marketed to its customers that included a particular vendor's contributions and trigger calculation and payment of a royalty to the vendor. This data, in some instances, can be maintained by and/or in connection with an enterprise resource planning system, and can be automated to automatically identify incoming invoice data to trigger up-to-date, and in some cases, real-time calculation of royalty values due for one or more software component vendors. The calculation of the vendor's royalties can be based on a calculation scheme developed from a combination of reusable software royalty calculation building blocks, or “step objects.”

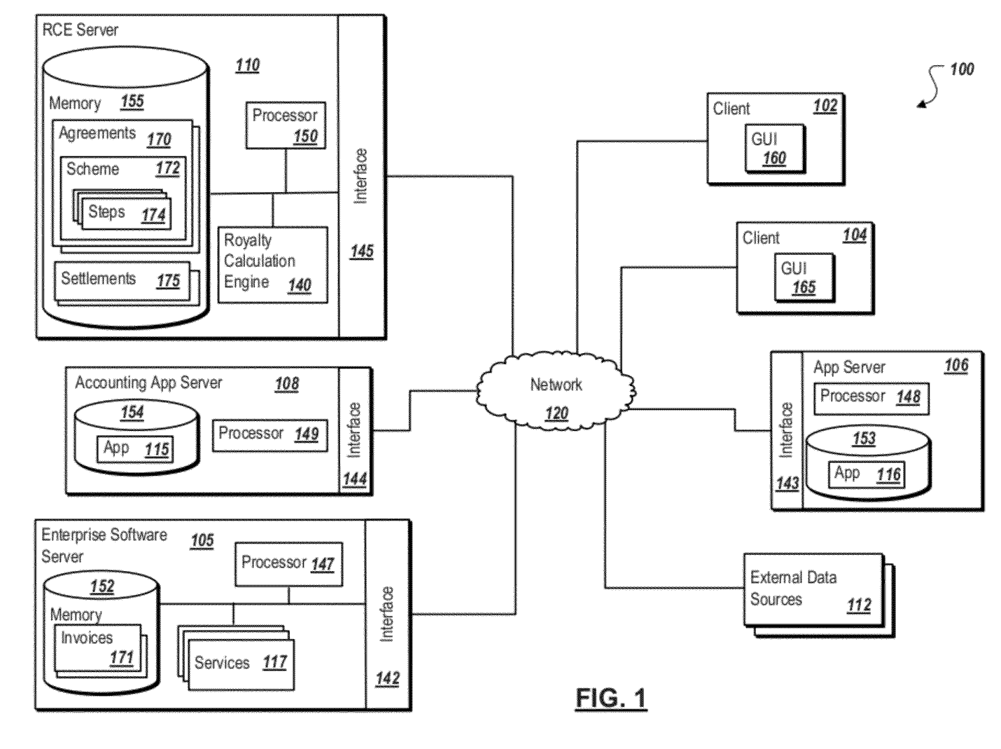

Turning to the example implementation of FIG. 1, the illustrated software environment 100 includes, or is communicably coupled with, one or more clients 102, 104, one or more enterprise system servers 105, one or more application servers 106, 108, a royalty calculation engine (RCE) server 110, and one or more data sources 112, using one or more networks 120. Each of the servers 105, 106, 108, 110 comprise electronic computing devices operable to receive, transmit, process, store, or manage data and information associated with the software environment 100. As used in this document, the term “computer” is intended to encompass any suitable processing device. For example, the environment 100 may be implemented using computers other than servers, including a server pool. Further, any, all, or some of the servers 105, 106, 108, 110 may be adapted to execute any operating system, including Linux, UNIX, Windows Server, or any other suitable operating system.

In the example embodiment illustrated in FIG. 1, the enterprise system server 105 is one or more computing devices used to provide enterprise software services to one or more customers, such as clients 102, 104. In some instances, an RCE server 110 can be provided in connection with an enterprise software system, such as an enterprise resource planning (ERP) system, to provide a scalable solution for managing royalty calculations for third-party software vendor accounts. The RCE server 110 can serve one or more instances of a royalty calculation engine 140 adapted to calculate software royalties due for third party vendors contributing to one or more products sold or licensed by a software provider. Additionally, the royalty calculation engine 140 can be used to calculate vendor royalties in connection with software products and services 117 served, sold, licensed, or otherwise provided by enterprise software system server 105. Indeed, in some instances, the royalty calculation engine 140 can be proprietary to and dedicated for use in connection with a particular enterprise software system, including an accounting application service 115 served by an accounting application server 108. In other instances, the royalty calculation engine 140 can be served as a reusable, scalable software service adapted for use by outside customers to calculate vendor royalties relating to products sold or licensed by the outside customers. Similarly, accounting application server 108 can be associated with the enterprise software environment, provided as a service through the enterprise software environment, or be offered independent of the enterprise software environment. Clients 102, 104, client applications (e.g., application 116 served by application server 106), as well as other users external to environment 100 or enterprise system server 105, can, directly or indirectly (e.g., via a proxy, virtual machine interface, etc.), access and use enterprise services provided by enterprise system server 105, including royalty calculation engine services provided through the RCE server 110.

Returning to FIG. 1, the RCE server 110 can include one or more processors 150 executing software comprising the royalty calculation engine 140. The RCE server 110 can be implemented using a single processor 150 or multiple processors, including multiple processors operating in a network or pool of computing devices, including parallel processing and cloud computing environments. The processor 150 executes instructions and manipulates data to perform royalty calculation engine 140 operations and tasks (described below) as well as access, manipulate, and manage data used in and generated by the royalty calculation engine 140. For instance, royalty calculation engine 140 can access and use agreement objects 170, including calculation schemes 172 comprising a set of step objects 174, to calculate software and maintenance royalties due for a particular vendor. Royalty calculation results can, in turn, be used by royalty calculation engine 140 to generate settlement documents 175, for example, through a settlement run procedure. At least a portion of agreement objects 170, calculation schemes 172, step objects 174, and settlement documents 175 used and generated by the royalty calculation engine 140 can be stored and maintained locally by the RCE server 110 (e.g., using one or more local memory devices 155), as well as accessed from other data sources associated, for example, with an enterprise software system, and remote sources, such as external data sources 112. Further, settlement documents 175 generated by the royalty calculation engine 140 can be posted or otherwise accessed and used by accounting applications (e.g., 115) to process and remit payments to corresponding third-party licensors/vendors.

In the present example, enterprise system servers 105, application servers 106, 108, and RCE servers 110 can each include at least one interface (142, 143, 144, 145, respectively), one or more processors (147, 148, 149, 150, respectively), and computer-readable memory (152, 153, 154, 155, respectively). In some instances, some combination of enterprise system servers 105, application servers 106, 108, and RCE servers 110 can be hosted on a common computing system, server, or server pool, and share computing resources, including shared memory, processors, and interfaces. The interfaces 142, 143, 144, 145 can be used for communicating with other systems in a client-server or other distributed environment (including within environment 100) connected to the network 120, for example the one or more clients 102, 104, external data sources 112, or any other computing device adapted to interface with the servers 105, 106, 108, 110, including devices not illustrated in FIG. 1. Generally, each interface 142, 143, 144, 145 comprises logic encoded in software and/or hardware in a suitable combination and operable to communicate with the network 120. More specifically, the interfaces 142, 143, 144, 145 may comprise software supporting one or more communication protocols associated with communications such that the network 120 or hardware is operable to communicate physical signals within and outside of the illustrated software environment 100.

Each of the example servers 105, 106, 108, 110 also includes a processor (147, 148, 149, 150, respectively). Each processor 147, 148, 149, 150 executes instructions and manipulates data to perform the operations of the associated server 105, 106, 108, 110, and may comprise, for example, a central processing unit (CPU), a blade, an application specific integrated circuit (ASIC), or a field-programmable gate array (FPGA), among other suitable options. Although each processor 147, 148, 149, 150 is illustrated as a single processor, multiple processors may be used according to the particular needs of the associated server. References to a single processor 147, 148, 149, 150 are meant to include multiple processors where applicable. The operations that each processor 147, 148, 149, 150 executes are determined by the purpose and operations of its associated server. Generally, the processor 147, 148, 149, 150 executes instructions and manipulates data to perform the operations of its respective server and, specifically, the software systems, services, and applications hosted by the servers 105, 106, 108, 110.

At a high level, each “server” (e.g., 105, 106, 108, 110) includes one or more electronic computing devices operable to receive, transmit, process, store, or manage data and information associated with the environment 100. Specifically, a server is responsible for receiving requests from one or more clients and sending the appropriate response to the requesting client. In addition to requests from external clients, requests may also be sent from internal users, external or third-party customers, other automated applications, as well as any other appropriate entities, individuals, systems, or computers. For example, although FIG. 1 illustrates a single server for each of enterprise system server 105, application server 106, accounting application server 108, and RCE server 110, a server can be implemented using two or more servers, as well as computers other than servers, including a server pool. Indeed, a server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, servers may be adapted to execute any operating system, including Linux, UNIX, Windows, Mac OS, or any other suitable operating system.

In the case of servers hosting, serving, or otherwise providing software services or products, a processor (e.g., 147, 148, 149, 150) can execute the functionality required to receive and respond to requests from clients, as well as client applications interfacing with the server's hosted application (e.g., 115, 116, 117, 140). It will be understood that the term “application server” (e.g., 106, 108) can include any suitable software component or module, or computing device(s) capable of hosting and/or serving a software application, including distributed, enterprise, or cloud-based software applications. Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. Applications can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate.

At a high level, each of the one or more hosted applications and services (e.g., 115, 116, 117, 140) illustrated in the environment 100 can include any application, program, module, process, or other software that may execute, change, delete, generate, or otherwise manage information according to the present disclosure, particularly in response to and in connection with one or more requests received from the illustrated clients 102, 104, as well as other applications. In certain cases, only one hosted application may be located at a particular server. In others, a plurality of related and/or unrelated hosted applications may be stored at a single server, or located across a plurality of other servers, as well. In certain cases, environment 100 may implement a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via the network 120 (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client (e.g., 102, 104). Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

Each of the example servers 105, 106, 108, 110 can also include a memory (152, 153, 154, 155, respectively). Further repositories 112 and computing devices (e.g., 102, 104) can also each include at least one memory device. Each memory may include any memory or database module and may take the form of volatile or non-volatile memory including, without limitation, non-transitory memory elements, magnetic media, optical media, random access memory (RAM), read-only memory (ROM), removable media, or any other suitable local or remote memory component. Each memory may store various objects or data, including classes, frameworks, applications, backup data, business objects, jobs, web pages, web page templates, database tables, content repositories storing business or other dynamic information, or other information including any parameters, variables, algorithms, instructions, rules, constraints, or references thereto relevant to the purposes of the particular server. Each memory may also include any other appropriate data, such as VPN applications, firmware logs and policies, firewall policies, a security or access log, print or other reporting files, as well as others. Again, the particular data and instructions stored in each memory (e.g., 152, 153, 154, 155) will be described in detail below in connection with the illustrated implementations of the software environment 100 and components thereof.

Generally, the network 120 facilitates wireless or wireline communications between the components of the software environment 100 (e.g., between the RCE server 110, accounting application server 108, application server 106, data sources 112, and one or more clients (e.g., 102, 104), as well as between other components as appropriate), as well as with any other local or remote computer, such as those associated with one or more applications or external data sources. The network 120 can be implemented as one or more distinct networks. In any implementation, the network 120 may be a continuous or discontinuous network without departing from the scope of this disclosure, so long as at least a portion of the network 120 may facilitate communications between senders and recipients. The network 120 may be all or a portion of an enterprise or secured network. As an example, in FIG. 1 networks 120 may represent a portion of an enterprise network, or a connection to the Internet. In some instances, a portion of the network 120 may be a virtual private network (VPN). All or a portion of the network 120 can comprise either a wireline or wireless link. Example wireless links may include 802.11a/b/g/n, 802.20, WiMax, and/or any other appropriate wireless link. In other words, the network 120 encompasses any internal or external network, networks, sub-network, or combination thereof operable to facilitate communications between various computing components inside and outside the illustrated environment 100. The network 120 may communicate, for example, Internet Protocol (IP) packets, Frame Relay frames, Asynchronous Transfer Mode (ATM) cells, voice, video, data, and other suitable information between network addresses. The network 120 may also include one or more local area networks (LANs), radio access networks (RANs), metropolitan area networks (MANs), wide area networks (WANs), all or a portion of the Internet, and/or any other communication system or systems at one or more locations.

The illustrated implementation of FIG. 1 includes one or more local and/or remote clients 102, 104. A client 102, 104 can be any computing device operable to connect or communicate at least with the application server 104 and/or the network 120 using a wireline or wireless connection. Each client 102, 104 includes at least one GUI (e.g., 160, 165). In general, the client 102, 104 comprises an electronic computing device operable to receive, transmit, process, and store any appropriate data associated with the software environment of FIG. 1. It will be understood that there may be any number of clients 102, 104 associated with environment 100, as well as any number of clients 102, 104 external to environment 100. Further, the term “client” and “user” may be used interchangeably as appropriate without departing from the scope of this disclosure. Moreover, while each client 102, 104 is described in terms of being used by one user, this disclosure contemplates that many users may use one computer or that one user may use multiple computers. As used in this disclosure, the client 102, 104 is intended to encompass a personal computer, electronic notepad, touch screen terminal, workstation, network computer, kiosk, wireless data port, smart phone, personal data assistant (PDA), one or more processors within these or other devices, or any other suitable processing device. For example, the client 102, 104 may comprise a computer that includes an input device, such as a keypad, touch screen, mouse, or other device that can accept information, and an output device that conveys information associated with operations of one or more applications stored and/or executed on an application server (or other servers in environment 100) or on the client 102, 104 itself, including digital data, visual information, or GUI 160, 165. Both the input device and the output device may include fixed or removable storage media such as a magnetic computer disk, CD-ROM, or other suitable media to both receive input from and provide output to users of the clients 102, 104 through the display, namely the GUI 160, 165.

The GUI 160, 165 comprises a graphical user interface operable to allow the user to interface with at least a portion of environment 100 for any suitable purpose, including allowing a user to interact with one or more software applications including royalty calculation engine 140, accounting application 115, and enterprise software services 117. Generally, the GUI 160, 165 provides users with an efficient and user-friendly presentation of data provided by or communicated within the system. The term “graphical user interface,” or GUI, may be used in the singular or in the plural to describe one or more graphical user interfaces and each of the displays of a particular graphical user interface. Therefore, the GUI 160, 165 can be any graphical user interface, such as a web browser, touch screen, or command line interface (CLI) that processes information in the environment 100 and efficiently presents the results to the user. In general, the GUI 160, 165 may include a plurality of user interface (UI) elements such as interactive fields, pull-down lists, media players, tables, graphics, virtual machine interfaces, buttons, etc. operable by the user at the client 108. These UI elements may be related to the functions of one or more applications or services (e.g., 115, 116, 117, 140), including applications hosted locally at the client.

While FIG. 1 is described as containing or being associated with a plurality of elements, not all elements illustrated within environment 100 of FIG. 1 may be utilized in each alternative implementation of the present disclosure. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

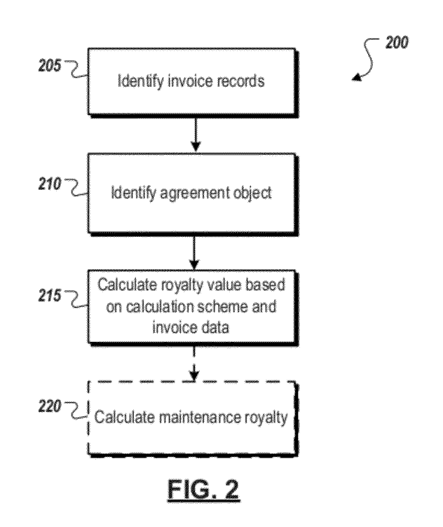

Turning now to the flowchart 200 of FIG. 2, an example technique is shown for calculating software royalties using a royalty calculation engine, such as the royalty calculation engine 140 shown and described in connection with FIG. 1. A plurality of invoice records can be identified 205 and accessed, for example, in an enterprise resource planning (ERP) system. The invoice records can include invoice data relating to service-based software provided by a particular entity to at least one customer of the particular entity. In some instances, the particular entity can be an enterprise software system provider and the at least one customer can be a consumer of services provided by the enterprise software system. The service-based software can include one or more software components provided by and licensed from a particular vendor for use by the particular entity in providing the particular entity's software products and services. As an example, a database or database management system provided by a third-party can be licensed to a particular entity and used in connection with a software product offered by the particular entity. A license agreement can exist between the entity and the third-party vendor dictating the payment of certain royalties by the particular entity in connection with the commercialization of the software product using the third-party database system.

At least one agreement object can be identified 210 that is associated with a license agreement between the particular entity and the third-party vendor relating to a particular software component provided by the third-party. The agreement object can include a calculation scheme adapted to calculate royalties due to the vendor/licensor according to the particular terms of the license agreement between the vendor/licensor and software provider/licensee entity. The calculation scheme can operate on invoice data in the identified invoice records pertaining to sales, licenses, or uses by the software provider/licensee of software products including or making use of software components licensed to the particular entity from the vendor. The calculation scheme can be composed of a plurality of reusable calculation step objects, adapted for use in calculating royalties. Using the calculation scheme and the invoice data, at least one software royalty value can be calculated 215, for example, for a particular calendar period. Further, in certain instances, the license between the vendor and licensee entity can provide for recurrent maintenance fee, or royalty, payments. In such instances, calculation of a license royalty can further include calculating 220 a maintenance royalty based, for example, on the invoice records, calculation scheme, and/or calculated software royalty values.

In some instances, calculation of software and maintenance royalties can be executed automatically, for example, according to a particular schedule. For instance, invoice records can be queried and collected from relevant billing documents received by the licensee/software provider from it's customers on a daily basis. When records are identified relevant to royalty calculations corresponding to a particular licensor/vendor, the software royalty calculation can be triggered. Additionally, at the close of a pre-defined maintenance period (such as a monthly, quarterly, or annual billing period defined in the corresponding license agreement) a royalty calculation engine can also automatically calculate maintenance royalties due to the licensor based on the underlying software royalties. Calculated royalty values can be collected in one or more database tables for use in connection with a settlement procedure adapted to generate pre-billing documents for use by accounting professionals in finalizing accounts payable relating to the license. Records stored in the database table can additionally be linked, keyed, or otherwise associated with other records, such as records identifying the underlying software license agreements and calculation schemes associated with the license agreement.

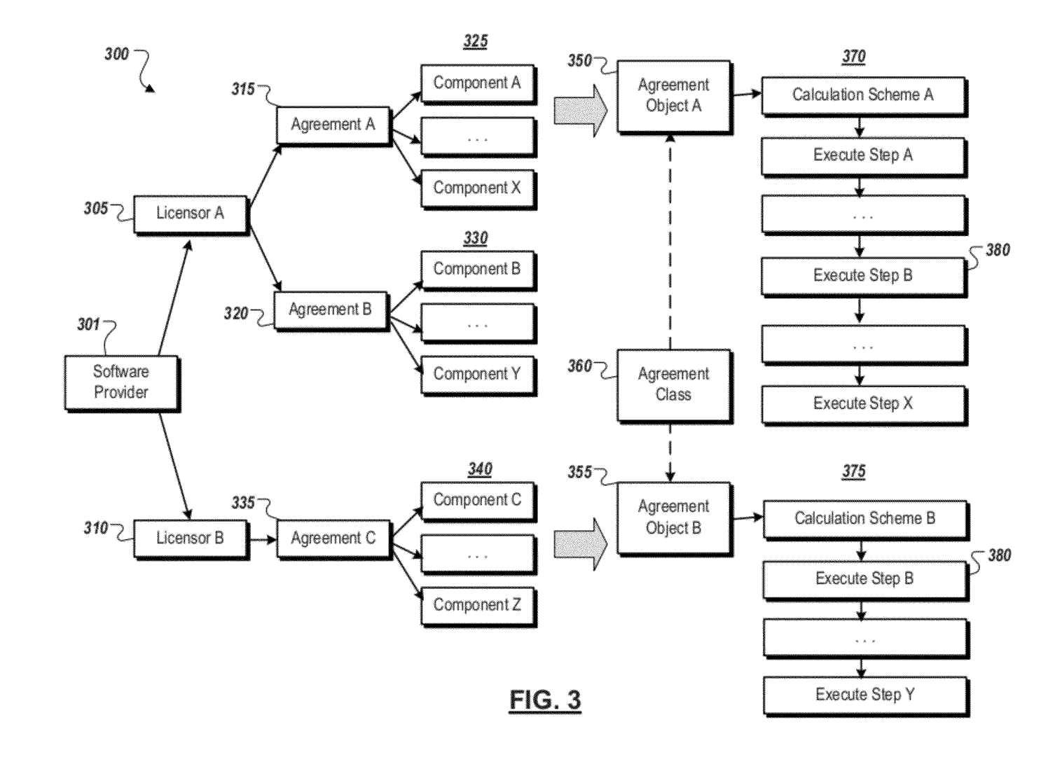

Turning FIG. 3, a schematic representation 300 is shown of example agreement objects 350, 355 for use in a software royalty calculation using a royalty calculation engine. An software provider/licensee 301 can utilize software components, such as databases, software modules, business objects, development components, virtual machine engines, applications, operating systems, and other components provided by third parties in software products sold or licensed by the software provider 301 to its customers. For instance, the software provider 301 may utilize and license software components (e.g., 325, 330, 340) from Licensor A 305 and Licensor B 310. The software provider 301 can have one or more license agreements 315, 320, 335 between itself and the licensors 305, 310 providing software components 325, 330, 340. As an example, a software provider 301 may have entered into two separate license agreements 315, 320 with a first Licensor A 305, each agreement 315, 320 directed to a separate set of software components (e.g., 325, 330 respectively), or modifying or supplementing terms of the other agreement.

Based on the agreements between the software provider 301 and the software component vendor/licensors 305, 310, one or more agreement objects 350, 355 can be developed. The agreement objects 350, 355 can be developed and defined by a user, for example, at or near the time the corresponding license agreement (e.g., 315, 320, 335) was entered into. Each agreement object 350, 355 can be defined in order to specify the parties, software products, software components included in the products, and other terms included in the corresponding license agreement(s). In some instances, such as shown in FIG. 3, a single agreement object (e.g., 350) can be developed for and incorporating the terms of more than one license agreement (e.g., 315 and 320). In other instances, agreement objects 350 can define terms for a single license agreement or a portion of a single license agreement (e.g., a portion of an agreement specifying terms for the license of a particular software component or group of components).

Agreement objects 350, 355 can be instantiated from a common agreement class 360. Further, each agreement object 350, 355 can include or reference a respective calculation scheme 370, 375 defining calculation steps needed to calculate a royalty payment based on the terms of the underlying license agreement and current invoice data. An agreement object 350, 355 can identify the corresponding calculation scheme, read the scheme, and control execution of each step in the scheme. In some instances, a calculation scheme 370, 375 can be constructed reusable step objects. Each step object can perform a particular task, function, or calculation relating to the calculation of a license royalty due under a particular license agreement. Step objects can take, among other inputs, invoice data and calculate a component value used in the generation of the overall royalty value. Further, as step objects are reusable, more than one calculation scheme can make use of a single step object, or step object type, such as shown in FIG. 3 through the inclusion of Step B 380 in both Calculation Schemes A 370 and B 375.

In some instances, step objects can be instantiated from a set of step classes. Step objects instantiated from a particular step class can inherit characteristics and functionality from the parent class. Further, in some examples, step objects instantiated from a particular step object class can be customized beyond the functionality inherited from the parent class, for example, to meet the particular requirements of the license terms modeled using the step object. In some instances, changing a particular instance of a calculation step class can create a new class. In one example, step classes can include a filter step, calculation step, and recalculation step object classes. Filter step objects can be used, for example, to filter particular invoice data for use in other calculation steps according to particular terms in a corresponding license agreement. For instance, among the software provider's 301 customers, sales or licenses to particular customer types may be treated differently from other customers and require a higher or lower license to be paid to the licensor. A filter step object can be used, in this example, to select, or filter invoice data by customer type, sales order type, invoice type, material type, sales organizations, and other data that should typically be reported (but not necessarily settled). Calculation step objects can perform standard royalty calculation steps based on specified invoice data. Calculation step objects can, for example, carry out simple percentage calculations, as well as recurring, subscription-based royalty calculations, among other calculations, according to the terms of the underlying license agreement. For instance, calculations can include fixed amounts per sales order item or invoice item, quantity-dependant amounts per sales order item or invoice item, item quantity or item value scale-dependant royalties, sales-order-header or invoice-header-dependent royalties, time dependant or sales organization dependant conditions, and other calculations. Recalculation step objects can perform operations on other calculation results and invoice data to capture special licensing terms that require a change to a standard or default royalty calculation (made, for example, using a calculation step object) to account for special agreements between the software provider 301 and licensor 305, 310. Special agreement terms can include special bid offers, reductions, deductions, and discounts, special agreement terms dependant on material, material type, sales organization, distribution channel, and agreement terms that are time dependant, subject to upper limits, and relevant to non-software terms.

In some examples, in addition to determining a software royalty, relating to the sale or licensing of a particular software product, other step objects and functions can be provided in connection with a royalty calculation engine to calculate a maintenance royalty value due to a particular licensor. A maintenance royalty can be calculated, for example, based on invoice data as well as calculated software royalty values. While in some instances, software royalties may comprise a one-time royalty payment based on a particular sale of a software product including the licensed component, maintenance royalties can be recurring payments based on the number of the software provider's 301 customers that continue to use the software product. Further, in some instances, selection step objects, instantiated from a selection step class can be used in connection with a maintenance royalty calculation. Selection step objects can be used in both software royalty and maintenance royalty calculations to select the particular invoice data to which the calculation applies, for instance, by selecting invoice data associated with the corresponding license agreement, software components, and/or vendor/licensors.

Utilizing reusable royalty calculation step objects can allow for a potentially limitless range of calculation schemes, some simple, some complex, and each adapted to calculate royalty payments based on received invoice data and particular license terms. As software license terms can vary substantially among various vendors and software components, developing an automated system to calculate royalties for a large number of licenses, with some licenses themselves encompassing multiple, licensed software components and licensing terms, calculating royalty rates can be quite cumbersome. Through the use of a reusable set of calculation step object building blocks, however, customized, agreement-specific calculation schemes can be developed flexibly and easily, without the need to develop and program royalty calculation functions from scratch with the addition of each new license.

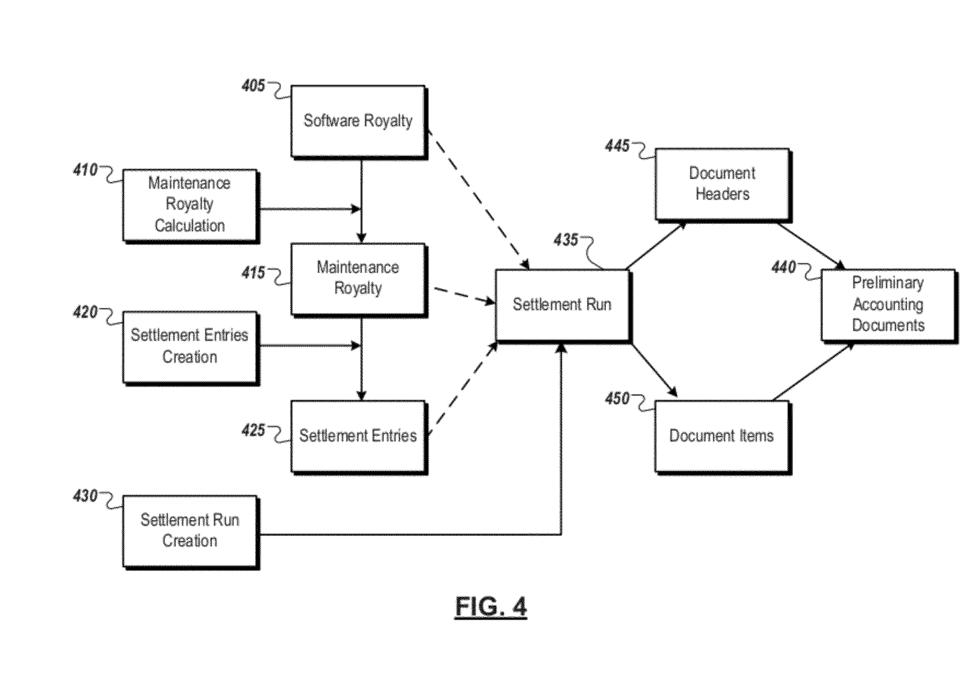

Turning now to the flowchart 400 of FIG. 4, an example technique is shown for calculating royalties and generating a settlement run. A settlement run can generate preliminary accounting documents (e.g., settlement run records) documenting royalties to be paid to licensors in accordance with royalty values calculated by a royalty calculation engine. Additionally, settlement run records can populate and be maintained in a data repository, such as a database, for example, for tracking, modification, and use by accounting professionals in processing payment to a licensors.

Settlement runs can be created following the calculation of software royalty and/or maintenance royalty values in connection with royalty values. For instance, as shown in FIG. 4, a software royalty 405 can be calculated, for example, according to a technique similar to that shown and described in FIG. 2. A maintenance royalty can be calculated 410 based on the software royalty 405. With one or more of the maintenance royalty 415 and software royalty 405 calculated, a settlement request can be received to create 420 settlement entries 425 for storage in a data repository, such as a settlement database. Settlement entries 425 can be created for maintenance royalties, and other royalties, in advance of creating a settlement run 435, to assist in generating a set of data from which a settlement run can be generated. Settlement entries 425 can be based on underlying software royalty and invoice data and serve as the basis of the settlement run 435. Settlement entries 425 can be used to restrict the set of data upon which the settlement run will be created, thereby reducing the complexity of the settlement run calculation. For instance, as maintenance royalties can be specific to a particular calendar term, the settlement run may not need data outside of the calendar term. Accordingly, in this example, settlement entries may be limited to that set of data necessary for calculating the corresponding settlement run 435. In addition, settlement entries can also be used in non-settlement contexts, such as the creation of non-settlement reports and documentation, such as in internal reporting documents.

A settlement run 435 can be initiated upon receipt of a request 430 to initiate a settlement run 435. The settlement run can collect data including calculated software royalty 405 and maintenance royalty 415 values, as well as settlement entries 425 for one or more license agreements or one or more vendors to generate pre-booking, or preliminary accounting documentation 440 for use, review, and/or approval by accounting personnel. In some instances, preliminary accounting documents 440 can be constructed from document header objects 445, for example, specifying information concerning the licensor, the license agreements, and time period at issue, and document items 450 specifying, for example, royalty values, royalty rates, royalty component line items, and other royalty-related information.

Preliminary accounting documents 440 created during a settlement run can include pre-booking documents specifying amounts a licensee/software provider has to pay its respective licensor/vendors for a particular period, as well as documents for intercompany reallocation of royalties in instances where a parent or headquarter entity handles payment of royalties for subsidiary and child entities. After approval of preliminary accounting documents 440 by an accounting professional or department, using for example, one or more separate accounting applications, preliminary accounting documents 440 can be converted or posted as actionable accounting documents. Further, in some implementations, a royalty calculation engine can provide additional functionality in connection with preliminary accounting documents 440 to allow for accounting personnel to deny approval of a particular preliminary accounting document 440 and tag the document with reasons for its disapproval or non-compliance. A preliminary accounting document 440 can be viewed, modified, and the underlying data and calculations examined to identify potential errors in the preliminary accounting document 440. Additionally, records can be maintained for individual preliminary accounting documents 440, for instance in an accounting or pre-booking document database, showing the status of the document (e.g., whether a particular preliminary accounting document 440 has been denied, posted, corrected, etc.) as well as identify or link to other documents and data, such as actionable accounting documents based on the preliminary accounting document or copies of the underlying license agreement.

In one example implementation of a royalty calculation engine software royalties are calculated by executing a software royalty (SW) calculation (CALC) program “CALCSW.” This program can be executed in batch mode on a daily basis by selecting the relevant billing documents, calculating the royalties, and storing the results in database table VLA. In some instance, to calculate software royalties the program needs the licensor, the license materials and the corresponding, customized royalty calculation scheme. Licensor data can be stored in database table LIP1. The license percentages corresponding to the licensed software components can be stored in database table VLIP. If these percentages should be dependent on a time interval or sales organization or division, these conditions can be stored in table VLIPC. Further, depending on the implementation, for every licensor/vendor or agreement, corresponding calculation scheme data can be stored and maintained in a database table LICS. Each calculation scheme can be composed of a set of calculation steps provided, for example, by a set of calculation step objects.

When a calculation scheme is executed, each calculation step can be executed and the corresponding results of each step written to table VLA_PROT. A class CL_LI_RCE_CONTROL_SW can select the relevant billing documents and control the calculation process. The CL_LI_RCE_CONTROL_SW class can create an instance for every licensor or agreement of class CL_LI_RCE_AGR_SW. This class can further read the assigned calculation scheme and executes it step by step. Doing so, new maintenance royalty value entries can also be calculated and written to table VLAM depending on the values of software royalties identified and entered into table VLA during the course of the previous, relevant time period (e.g., month, quarter, etc.). For these new maintenance royalty entries, corresponding maintenance license fees are typically recurrently paid until the corresponding software sales order is cancelled. In some instances, the maintenance percentages can be stored in table LIP1 for each licensor. The maintenance royalty rate can be, for example, an annual rate. If there is no corresponding maintenance royalties to be paid in connection with a particular vendor/licensor or software component, a value of “0” can be entered in the table. Further, in calculating a maintenance royalty, the relevant date range, and software royalty values or invoice data corresponding to this range, can be identified, as well as the term of the maintenance royalty (e.g., monthly, quarterly or yearly). This information can also be extracted from table VLAM. Based on the value of the software license royalties for a given period, the maintenance royalty can be calculated, for example, by multiplying the software royalty by the maintenance royalty rate and dividing the result (for a monthly royalty) by 12. This amount, as well as the software royalty values, can be converted to the appropriate currency of the licensor as specified, for example, in table LIP1. Relevant data can be selected, for example, for every licensor/vendor, and an instance of class CL_LIT_RCE_AGR_MT can be created. The class can further select, for every licensor, the corresponding customizing data from entries in table ZZLIP1, as well as tables RCE_CALC_PROC_H and RCE_CALC_PROC_I in which corresponding calculation schemes are saved. The classes assigned to the calculation steps will be called by class CL_LIT_RCE_AGR_MT in the correct order. Part of the calculation scheme can include, for example, filter class CL_LI_RCE_MT_FILTER_BS and calculation class CL_LI_RCE_MT_ROY_CALC_BS.

After creation and calculation of maintenance royalties, the corresponding settlement entries can be created and stored in table VLAMP based on the calculated maintenance royalty and/or software royalty entries stored in the database. These entries can be checked to ensure that the dates of the entries correspond to the relevant settlement period. Settlement entries can be computed for a certain period and according to a certain schedule. For instance, settlement entries for a particular vendor can be calculated monthly, quarterly, etc., according to the terms of the underlying license agreement. These and other conditions can also be stored and referenced in a database. Calculation of settlement entries can be completed by calling a CREATE_SETTLEMENT_ENTRIES method.

As described above, in some instances, a settlement run can be executed to create preliminary accounting documents. Settlement runs can be saved, for example, in table RCE_SETTL_RUN. Software royalty values and maintenance royalty values stored in tables VLA and VLAMP can be “settled” through the settlement run procedure. Corresponding software royalty values and maintenance royalty values can be assigned by settlement run ID. Additionally, each preliminary accounting documents created through a settlement runs can be assigned and referenced to a settlement run ID so as to link the preliminary accounting documents to the corresponding settlement run. To create a settlement run the function “Create settlement runs” of the royalty calculation engine can be executed. Finalized accounting documents can be further generated from the preliminary accounting documents by posting the documents, for example, by executing the “Post Creditor documents” and/or “Intercompany Postings” methods. During posting, a protocol can also be created and stored in the database and linked to the corresponding settlement run.

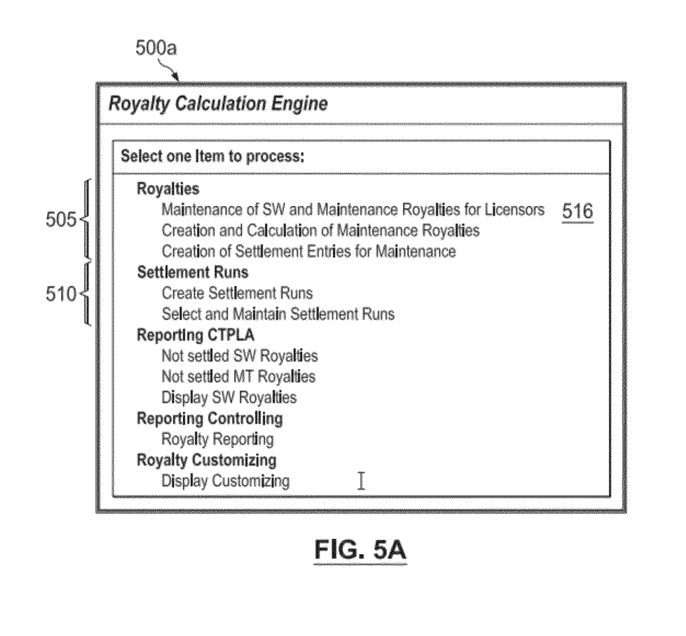

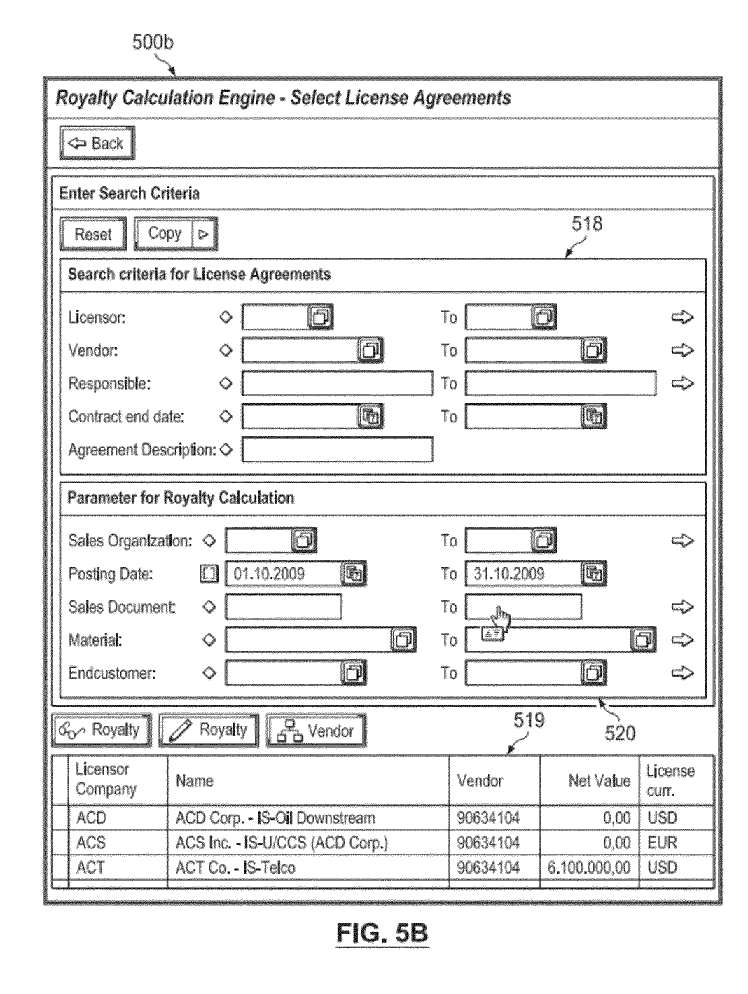

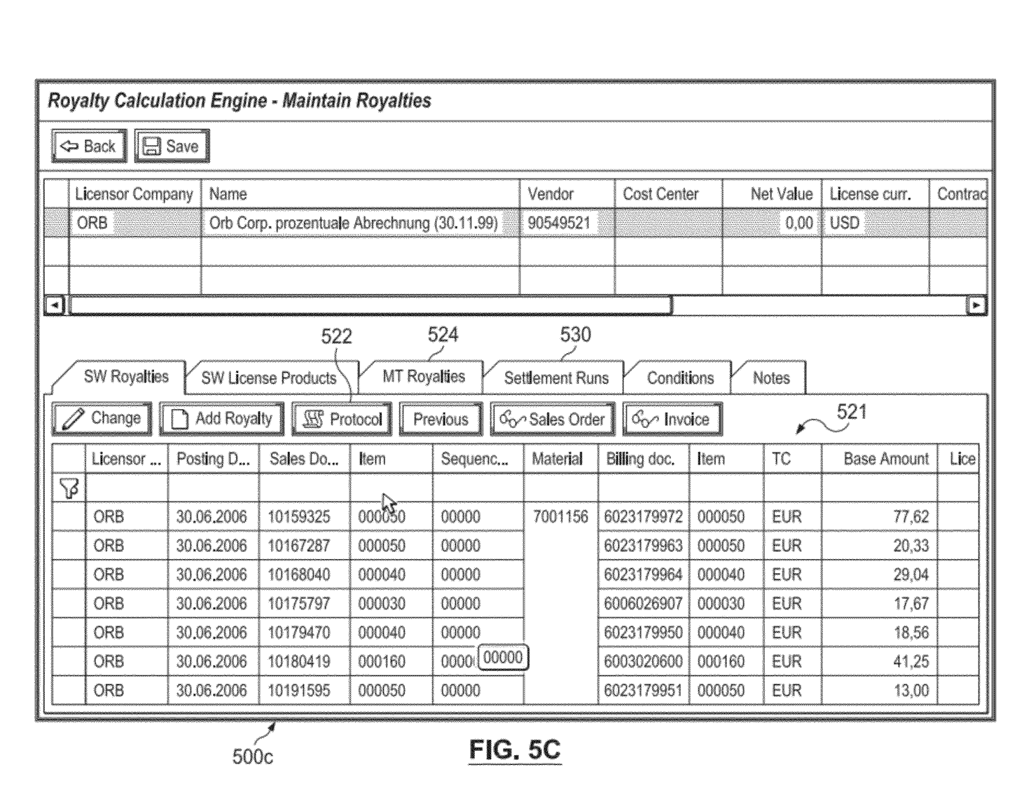

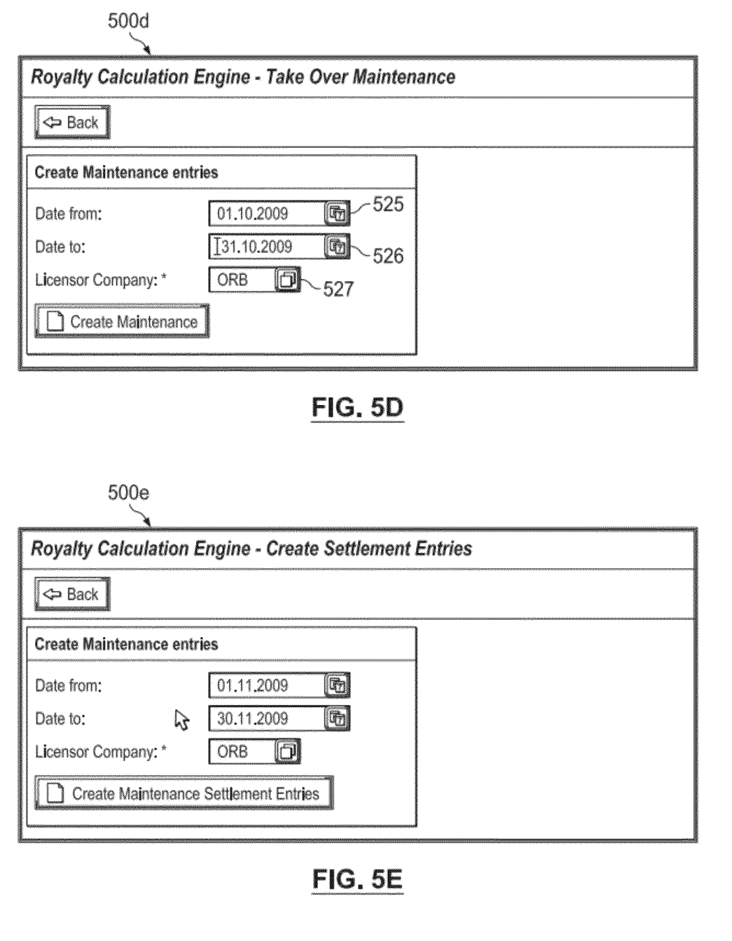

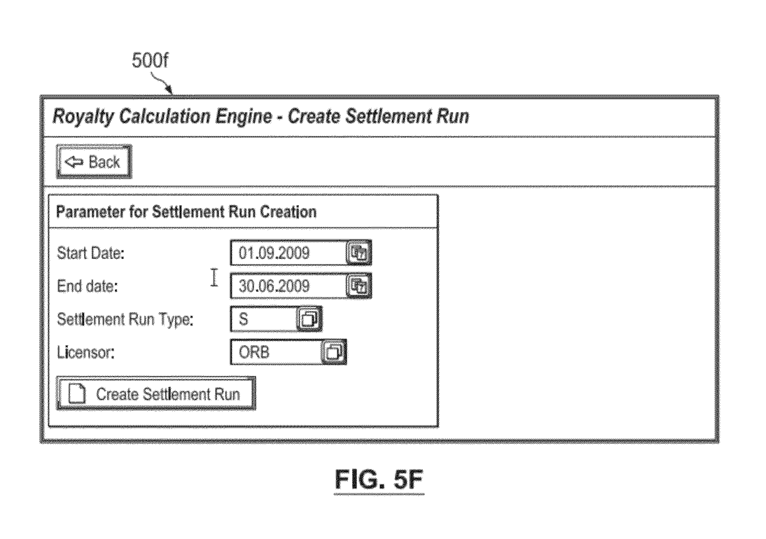

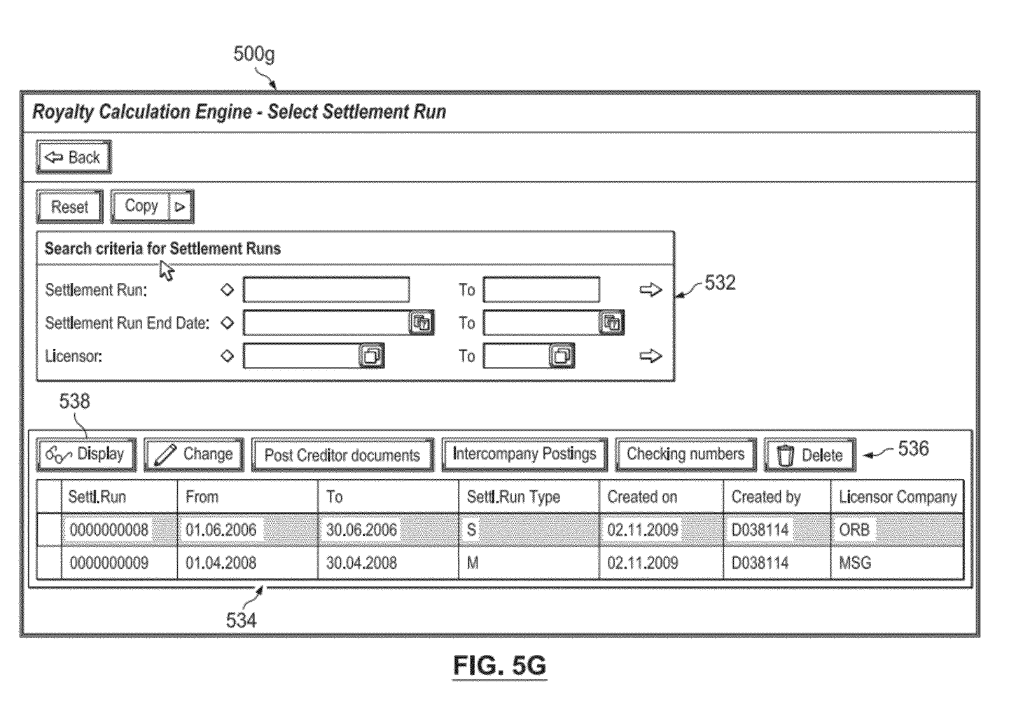

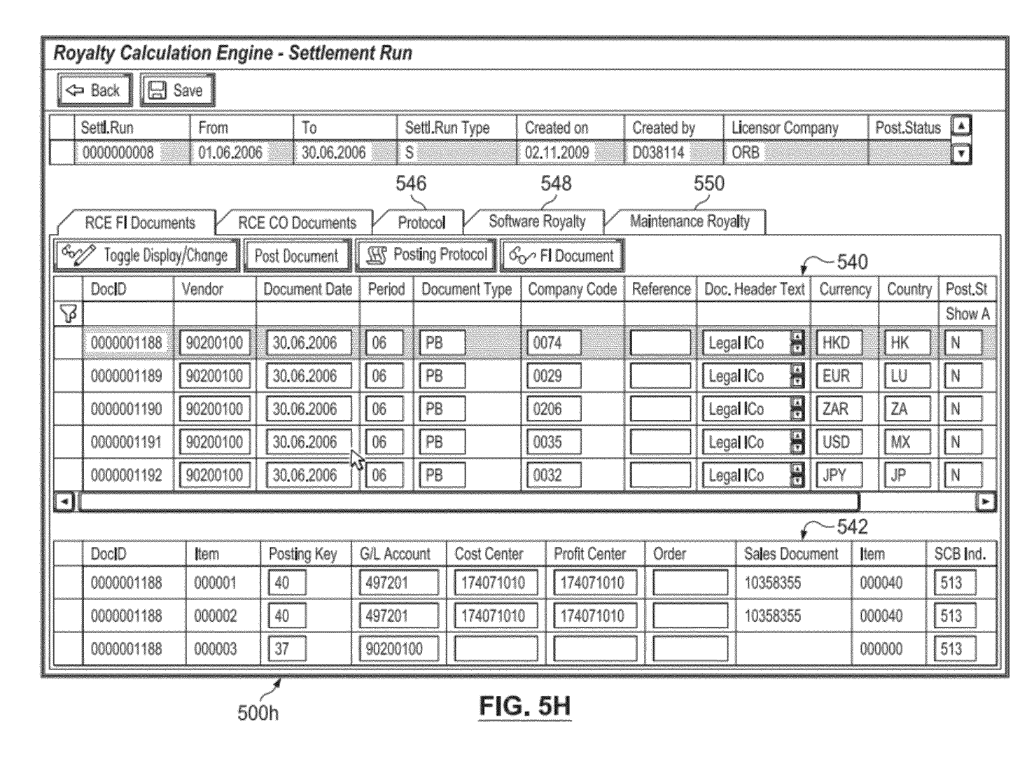

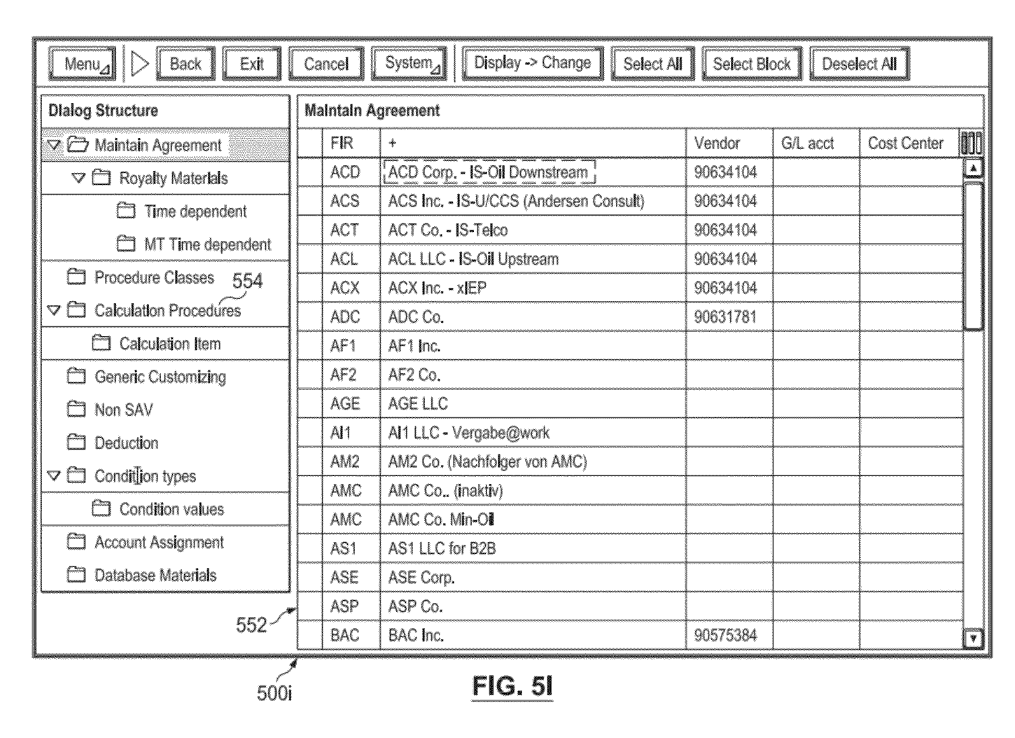

FIGS. 5A-5I are example screenshots of a user interface 500 of an example royalty calculation engine. For instance, FIG. 5A shows an example dashboard for use by accounting personnel that incorporates links to functionality provided by a royalty calculation engine as well as an accounting application. For example, a dashboard interface 500a can include a plurality of hyperlinks directed to royalty calculation 505 and settlement run creation 510, as well as other functions including reviewing settlement status of calculated royalties, royalty reporting, and royalty calculation customization, including calculation scheme generation. Continuing with this example, if a user selects link “Maintenance of SW and Maintenance Royalties for Licensors” 516, an interface 500b, shown in FIG. 5B, can be presented to a user including fields 518 for building a query to search a depository of agreement records included, for example, in an ERP system. In response to the search terms entered in fields 518, a listing 519 of search results can be returned, identifying one or more agreements matching the criteria input in fields 518. Additionally, other fields 520 can be provided, such as other search-related fields.

A user can select one or more agreement returned in listing 519 of user interface 500b illustrated in FIG. 5B. A user can, in some implementation, specify a particular action to be performed on the selected agreement, for example to view details, edit, or view corresponding vendor/licensor data. In some instances, selection of a particular agreement returned in results listing 519 can result in a Maintain Royalties interface 500c being displayed to the user, an example of which is shown FIG. 5C. Using interface 500c, a finance or accounting professional or manager can modify and even manually create royalties. Royalties can be displayed in a table 521, for example, for inspection and selection by a user. Additionally, a user can inspect a royalty's underlying calculation scheme to ensure that the scheme is correct by, for example, selecting Protocol button 522 and specifying one or more of the royalties displayed in table 521. Additionally, after creating, modifying, or verifying a particular software royalty presented in connection with interface 500c, a user can additionally select tab 524 labeled “MT Royalties” to edit, view, and add corresponding maintenance royalties. For example, as shown in FIG. 5D, a screen 500d can be presented in connection with the MT Royalties tab allowing a user to create a new maintenance royalty by defining a particular term of the maintenance royalty using, for example, fields 525, 526, 527.

Additional interfaces 500e, 500f, 500g (shown in FIGS. 5E, 5F, and 5G respectively) can be also be accessed via one or more of the interfaces of the royalty calculation engine, including interface 500a. For instance, an interface 500e, shown in FIG. 5E, can be presented to a user through which particular settlement entries can be created corresponding to a particular time period. In some instances, an interface 500f, shown in FIG. 5F, can also be accessed by a user allowing for a particular settlement run to be created for a particular period. Existing or newly-created settlement runs can be accessed and managed by a user using a user interface similar to the example Select Settlement Run interface 500g illustrated in FIG. 5G. Indeed, as shown in FIG. 5G, a search functionality can be provided allowing users to search for and select a particular settlement run according to particular search criteria. User can enter search terms, for example, in fields 532 and a listing 534 of search results can be generated in response. A user can select one or more settlement runs presented to the user (e.g., in search results listing 534), and select one or more operations in toolbar 536 to be performed on the selected settlement run(s). For instance, a user can select “Display” button 538 to allow the user to view details of a particular settlement run, as shown, for example, in interface 500h of FIG. 5H. As shown in FIG. 5H, financial and control documents 540, including preliminary, pre-booking documents, associated with the selected settlement run, can be presented to a user. Items included in the listed documents can be viewed as well, for example, in window 542, showing items relating to highlighted document “0000001188.” Further data pertaining to a particular settlement run can also be accessed, viewed, verified, and, in some cases, modified. For example, a user can select “Protocol” tab 546 to examine a posting protocol associated with the settlement run to identify, for example, if any errors occurred during posting of the settlement run. Further, software and maintenance royalty data underlying a particular settlement run can be displayed and examined, for example, by selecting tabs “Software Royalty” 548 and “Maintenance Royalty” 550 respectively.

Other interfaces can be provided in connection with a royalty calculation engine, such as interfaces relating to reporting and control functions of an organization. Still other interfaces can be provided, for example, to assist users in building and otherwise customizing aspects of data relating to a particular royalty, assignment agreement, licensor, or calculation scheme, such as shown in FIG. 5I. For example, as shown in example interface 500i, a user can select a particular license agreement from listing 552 and select particular attributes for customization, such as calculation schemes 554 pertaining to the selected license agreement. For instance, a user can select, view, edit, and build a calculation scheme for a particular licensor or agreement, for example, using a set of standard calculation step objects, such as those described above.

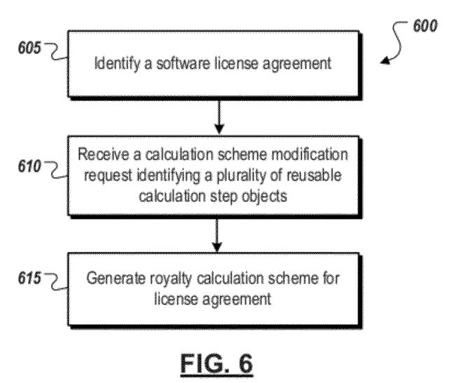

FIG. 6 illustrates a flowchart 600 of an example technique for generating a calculation scheme for use in calculating a royalty value. A software license agreement, including data records memorializing aspects of the agreement, can be identified 605 between a software provider and a particular vendor associated with the vendor's licensing of a particular software component to the software provider. The software component can be included in service-based software provided by the software provider to at least one of its customers. A request to modify (or create) a calculation scheme associated with the license agreement can be received 610, where the request identifies a plurality of reusable calculation step objects related to a plurality of terms in the license agreement. Each calculation step object can be an instantiation of a calculation step class, such as a selection, filter, calculation, or recalculation step class, as described above. Further, a calculation scheme associated the license agreement can be generated 615 from the identified calculation step objects, including a particular sequence for execution of the identified calculation step objects. The calculation scheme can be associated with an instance of an agreement object class and can be further associated with multiple assignment agreements between the software provider and the particular vendor/licensor. The generated calculation scheme can be a new calculation scheme or an updated, or modified, calculation scheme, based on the request to modify received at 610. Indeed, modification of a calculation scheme, in this context, can include the generation of a wholly new calculation scheme. Calculation schemes, generally, can be adapted, when executed, to calculate at least one royalty value based at least in part on the plurality of license terms and invoice data associated with at least one sale of the service-based software and the respective calculation step objects executed in accordance with the generated calculation scheme.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Other variations are within the scope of the following claims.

What is claimed is:

1. A computer-implemented method comprising:
identifying a plurality of invoice records in an enterprise resource system, the enterprise resource system including at least one computer-readable storage device, the plurality of invoice records relating to service-based software provided by an entity to at least one customer of the entity, the service-based software including at least one first software component licensed from a first vendor for use by the entity;
identifying, in a computer readable medium by operation of a computer, a first agreement object associated with a first license agreement between the entity and the first vendor and associated with the first software component, the first license agreement including a first plurality of license terms, the first agreement object associated with a first calculation scheme based at least in part on the first plurality of license terms, the first calculation scheme including a first set of calculation step objects from a plurality of reusable calculation step objects; and
calculating, using at least one computing device, at least one first software royalty value for the first license agreement, the calculation of the first software royalty value based at least in part on the first calculation scheme and first invoice data included in the plurality of invoice records, the first invoice data corresponding to at least the first software component; and
generating, using at least one computing device, at least one preliminary accounting document based at least in part on the calculated first software royalty value.

2. The method of claim 1, wherein each step object is an instantiation of a step class in a set of step classes.

3. The method of claim 2, wherein the set of step classes includes a filter class, a royalty calculation class, and a recalculation class.

4. The method of claim 3, wherein a filter step object instantiated from the filter class is adapted to designate a particular subset of the first invoice data to be operated upon by at least one other calculation step object.

5. The method of claim 3, wherein a royalty calculation step object instantiated from the royalty calculation class is adapted to calculate a base royalty value based on at least a portion of the first invoice data.

6. The method of claim 3, wherein a recalculation step object instantiated from the recalculation class is adapted to modify a base value calculated by at least one royalty calculation step object, wherein modification of the base value is based at least in part on at least one special term included in the plurality of license terms.

7. The method of claim 1 further comprising calculating a first maintenance royalty value for the first license agreement over a particular period based at least in part on the first invoice data.

8. The method of claim 7, wherein each step object is an instantiation of a step class in a set of step classes, the set of step classes including a selection class, wherein a selection object instantiated from the selection class is adapted to identify the first invoice data in the plurality of invoice records.

9. The method of claim 1, wherein the first agreement object is associated with a plurality of software components licensed from the first vendor for use by the first entity.

10. The method of claim 1, wherein the at least one preliminary accounting document comprises an electronic document.

11. The method of claim 1 wherein the service-based software including a second software component licensed from a second vendor for use by the entity, the method further comprising:
identifying a second agreement object associated with a second license agreement between the entity and the second vendor and associated with the first software component, the second license agreement including a second plurality of license terms, the second agreement object associated with a second calculation scheme based at least in part on the second plurality of license terms, the second calculation scheme including a second set of calculation step objects from the plurality of reusable calculation step objects; and
calculating a second software royalty value for the second license agreement, the calculation of the second software royalty value based at least in part on the second calculation scheme and second invoice data included in the plurality of invoice records, the second invoice data corresponding to at least the second software component.

12. The method of claim 11, wherein the first set of calculation step objects and the second set of calculation step objects each include at least one common calculation step object.

13. The method of claim 1, wherein calculating the at least one software royalty value includes executing each calculation step object in the plurality of reusable calculation step objects included in the first calculation scheme.

14. The method of claim 1, wherein the agreement object is adapted to read the first calculation scheme and execute each calculation step object in the plurality of reusable calculation step objects according to a particular sequence.

15. The method of claim 1, wherein the invoice records are automatically searched and identified according to a particular schedule.

16. The method of claim 1, wherein identification of at least one new invoice record associated with the first software component automatically triggers calculation of at least one corresponding software royalty value.

17. An article comprising a non-transitory, machine-readable storage device storing instructions operable to cause at least one processor to perform operations comprising:
identifying a plurality of invoice records in an enterprise resource system relating to service-based software provided by a first entity to at least one customer of the first entity, the service-based software including at least one software component licensed from a first vendor for use by the first entity;
identifying at least one agreement object associated with a license agreement between the first entity and the first vendor and associated with the at least one software component, the license agreement including a plurality of license terms, the agreement object including a calculation scheme based at least in part on the plurality of license terms and including a plurality of reusable calculation step objects; and
calculating at least one software royalty value for the license agreement over a particular period, the calculation of the at least one software royalty value based at least in part on the calculation scheme and invoice data included in the plurality of invoice records, the invoice data corresponding to the at least one software component.

18. A computer-implemented method comprising:
identifying, using at least one computing device, a particular agreement between a first entity and a first vendor and associated with a first software component included in service-based software provided by the first entity to at least one customer of the first entity, the service-based software, wherein the first software component is licensed from the first vendor for use by the first entity according to a plurality of license terms included in the particular agreement;
receiving a request to modify a calculation scheme associated with at least the particular agreement, the request identifying a plurality of reusable calculation step objects, each calculation step object in the plurality of reusable calculation step objects instantiated from a set of calculation step classes; and
generating, using at least one computing device, the calculation scheme associated with at least the particular agreement, the calculation scheme including the plurality of reusable calculation step objects and adapted, when executed, to calculate at least one royalty value based at least in part on the plurality of license terms and invoice data associated with at least one sale of the service-based software.

19. The method of claim 18, wherein execution of the calculation scheme includes executing each calculation step object in the plurality of reusable calculation step object.

20. The method of claim 18, wherein the set of calculation step classes at least includes:
a selection class adapted to identify relevant invoice data from a plurality of invoice records;
a filter class adapted to designate a particular subset of the relevant invoice data to be operated upon by at least one other calculation step object,
a royalty calculation class adapted to calculate a base royalty value based on at least a portion of the invoice data, and
a recalculation class adapted to modify a base value calculated by at least one royalty calculation step object instantiated from the royalty calculation class, wherein modification of the base value is based at least in part on at least one special term included in the plurality of license terms.

21. An article comprising a non-transitory, machine-readable storage device storing instructions operable to cause at least one processor to perform operations comprising:
identifying a particular agreement between a first entity and a first vendor and associated with a first software component included in service-based software provided by the first entity to at least one customer of the first entity, the service-based software, wherein the first software component is licensed from the first vendor for use by the first entity according to a plurality of license terms included in the particular agreement;
receiving a request to modify a calculation scheme associated with at least the particular agreement, the request identifying a plurality of reusable calculation step objects, each calculation step object in the plurality of reusable calculation step objects instantiated from a set of calculation step classes; and
generating the calculation scheme associated with at least the particular agreement, the calculation scheme including the plurality of reusable calculation step objects and adapted, when executed, to calculate at least one royalty value based at least in part on the plurality of license terms and invoice data associated with at least one sale of the service-based software.
